(19) United States
(12) Patent Application Publication
(10) Pub. No.: US 2013/0228227 A1
(43) Pub. Date: Sep. 5, 2013

(54) SIPHON ACTUATED FILTRATION PROCESS

(71) Applicants: Jeff J. Kempson, Ontario (CA); Jason R. Downey, Ontario (CA)

(72) Inventors: Jeff J. Kempson, Ontario (CA); Jason R. Downey, Ontario (CA)

(73) Assignee: CALCO ENVIRONMENTAL GROUP LTD., Ontario (CA)

(21) Appl. No.: 13/410,451

(22) Filed: Mar. 2, 2012

(51) Int. Cl. F04F 10/00; F17D 1/00

(52) U.S. Cl. 137/2; 137/123

(57) ABSTRACT

A system for actuating a water flow through a filter. The system includes a filtrate withdrawal conduit for being connected to the filter in a water sealing fashion for receiving filtrate therefrom. A filtrate collector is in fluid communication with the filtrate withdrawal conduit for collecting the filtrate. A filtrate siphon is interposed between the filtrate withdrawal conduit and the filtrate collector. A suction mechanism connected to a top portion of the filtrate siphon via an air conduit. The suction mechanism provides suction to the filtrate siphon which is sufficient for drawing the filtrate to the top portion of the filtrate siphon for actuating the water flow through the filter and the flow of filtrate from the filter to the filtrate collector.

This application claims priority to Canadian Patent Application No. ______, filed on Jan. 25, 2012, entitled SIPHON ACTUATED FILTRATION PROCESS, invented by Jeff J. Kempson and Jason R. Downey.

### FIELD

The present invention relates to the field of water treatment, and more particularly to a method and system for actuating a filtration process using a vacuum assisted siphon.

### BACKGROUND

In wastewater treatment the final step typically comprises a membrane filtration process where the water is filtered by drawing the same through a membrane filter such as, for example, an ultra-filtration membrane. In membrane filtration processes one or more membrane filter modules are typically disposed in a tank facility and submerged in the water that is to be filtered. The water is then drawn through the membrane filters at a controlled flow rate.

Present day systems typically employ a positive displacement water pump which is controlled using a pressure sensor and a variable frequency drive to provide a predetermined flow rate of water drawn through the membrane filters. Unfortunately, positive displacement water pumps are expensive and maintenance intensive. Furthermore, variable frequency drives tend to fail over time when operated using low quality electrical power such as, for example, generator power.

Alternatively, the water is drawn through the membrane filters by gravity with a shutoff valve to start and stop the flow of the water. However, this system does not enable to control the flow rate of the water drawn through the membrane filters in an automated fashion and does not enable provision of a reverse flow to clean the membrane filters. Furthermore, air bubbles present in the filtrate can cause the flow to stop prematurely requiring operator intervention.

Further alternatively, an air vacuum pump is employed to evacuate a large chamber for drawing the water through the membrane filters into the same. Once the chamber is full, the system is vented and the water in the chamber is discharged by gravity or using a water pump. Unfortunately, a variable flow rate of the water flow through the membrane filters is difficult if not impossible to achieve and it is expensive to build such a large vacuum chamber to achieve the desired filtration intervals. Furthermore, for optimum membrane use it may be desired to provide a reverse flow for relaxation of the membrane filters in regular time intervals. For example, the water is drawn through the membrane filters for approximately 9 minutes followed by a reverse flow for approximately 5 seconds and membrane relaxation for approximately 55 seconds or water is drawn through the membrane filters for approximately 9 minutes followed by a reverse flow for approximately 60 seconds. In order to enable such a cycle a large size chamber has to be employed requiring a substantial amount of time for evacuating the same.

It is desirable to provide a membrane filtration process having a mechanism for maintaining a constant flow rate of the filtrate.

It is also desirable to provide a membrane filtration process that is simple and compact.

It is also desirable to provide a membrane filtration process that requires substantially less maintenance and operator intervention.

It is also desirable to provide a membrane filtration process that enables implementation of predetermined cycles of filtration and membrane relaxation in an automated fashion.

It is also desirable to provide a membrane filtration process that enables implementation of pressurized reverse flow cleaning cycles.

### SUMMARY

Accordingly, one object of the present invention is to provide a membrane filtration process having a mechanism for maintaining a constant flow rate of the filtrate.

Another object of the present invention is to provide a membrane filtration process that is simple and compact.

Another object of the present invention is to provide a membrane filtration process that requires substantially less maintenance and operator intervention.

Another object of the present invention is to provide a membrane filtration process that enables implementation of predetermined cycles of filtration and membrane relaxation in an automated fashion.

Another object of the present invention is to provide a membrane filtration process that enables implementation of pressurized reverse flow cleaning cycles.

According to one aspect of the present invention, there is provided a system for actuating a water flow through a filter is provided. The system comprises a filtrate withdrawal conduit for being connected to the filter in a water sealing fashion for receiving filtrate therefrom. A filtrate collector is in fluid communication with the filtrate withdrawal conduit for collecting the filtrate. A filtrate siphon is interposed between the filtrate withdrawal conduit and the filtrate collector. A suction mechanism connected to a top portion of the filtrate siphon via an air conduit. The suction mechanism provides suction to the filtrate siphon which is sufficient for drawing the filtrate to the top portion of the filtrate siphon for actuating the water flow through the filter and the flow of filtrate from the filter to the filtrate collector.

According to another aspect of the present invention, there is further provided a method for actuating a water flow through a filter. A filtrate withdrawal conduit is connected to the filter in a water sealing fashion for receiving filtrate therefrom. A filtrate collector in fluid communication with the filtrate withdrawal conduit is provided. A filtrate siphon is interposed between the filtrate withdrawal conduit and the filtrate collector such that in operation a predetermined length of the end portion of the filtrate siphon is immersed in the collected filtrate. Suction is provided to the filtrate siphon sufficient for drawing the filtrate to the top portion of the filtrate siphon for actuating the water flow through the filter and the flow of filtrate from the filter to the filtrate collector.

One advantage of the present invention is that it provides a membrane filtration process having a mechanism for maintaining a constant flow rate of the filtrate.

A further advantage of the present invention is that it provides a membrane filtration process that is simple and compact.

A further advantage of the present invention is that it provides a membrane filtration process that requires substantially less maintenance and operator intervention.

A further advantage of the present invention is that it provides a membrane filtration process that enables implementation of predetermined cycles of filtration and membrane relaxation in an automated fashion.

A further advantage of the present invention is that it provides a membrane filtration process that enables implementation of pressurized reverse flow cleaning cycles.

### BRIEF DESCRIPTION OF THE DRAWINGS

One embodiment of the present invention is described below with reference to the accompanying drawings, in which:

FIG. 1a is a simplified block diagram illustrating a system for actuating a water flow through a filter according to an embodiment of the invention;

FIGS. 1b to 1e are simplified block diagrams illustrating the system for actuating a water flow through a filter shown in FIG. 1a in various stages of operation;

FIG. 1f is a simplified block diagram illustrating a detail of the system for actuating a water flow through a filter shown in FIG. 1a;

FIG. 2a is a simplified block diagram illustrating a system for actuating a water flow through a filter according to another embodiment of the invention;

FIGS. 2b and 2c are simplified block diagrams illustrating the system for actuating a water flow through a filter shown in FIG. 2a in different modes of operation;

FIG. 3a is a simplified block diagram illustrating a system for actuating a water flow through a filter according to yet another embodiment of the invention;

FIGS. 3b and 3c are simplified block diagrams illustrating the system for actuating a water flow through a filter shown in FIG. 3a in different modes of operation; and,

FIG. 4 is a simplified block diagram illustrating a control unit for controlling operation of the system for actuating a water flow through a filter shown in FIG. 3a.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While embodiments of the invention will be described for drawing water through an ultra-filtration membrane in a wastewater treatment process, it will become evident to those skilled in the art that the embodiments of the invention are not limited thereto, but are applicable for use with other submerged filtration media.

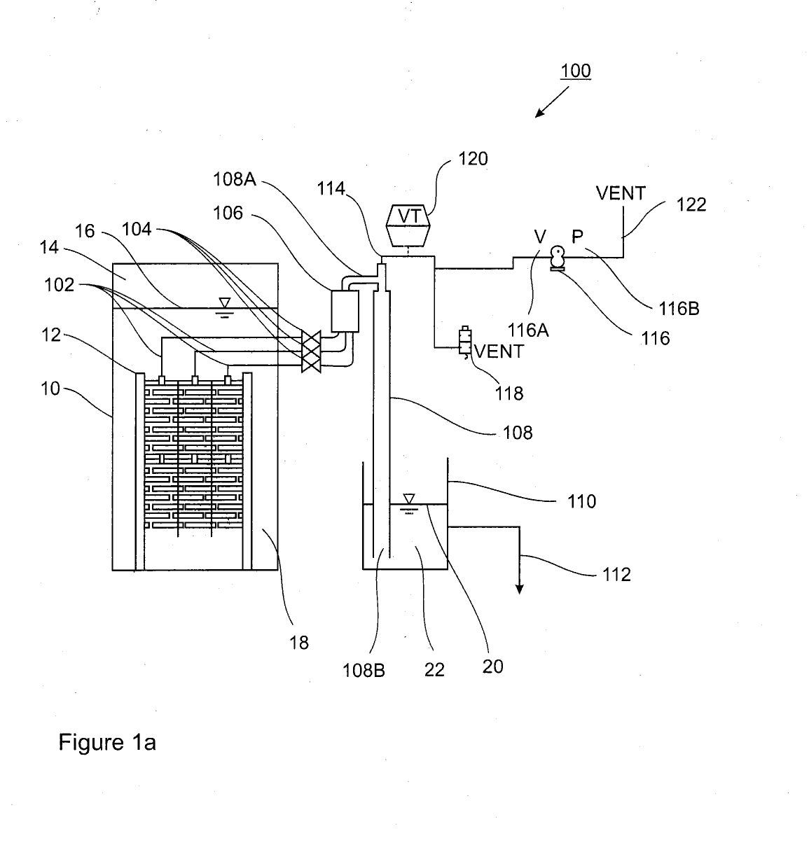

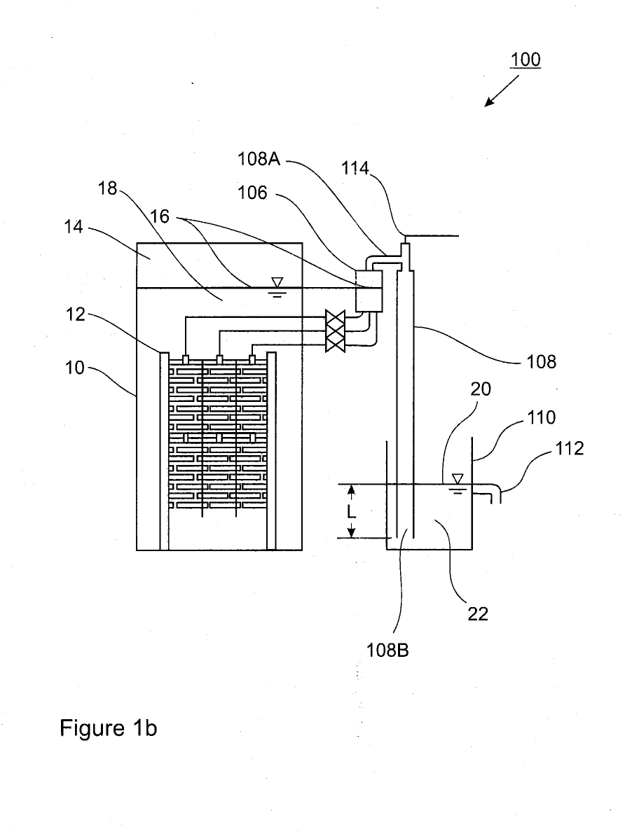

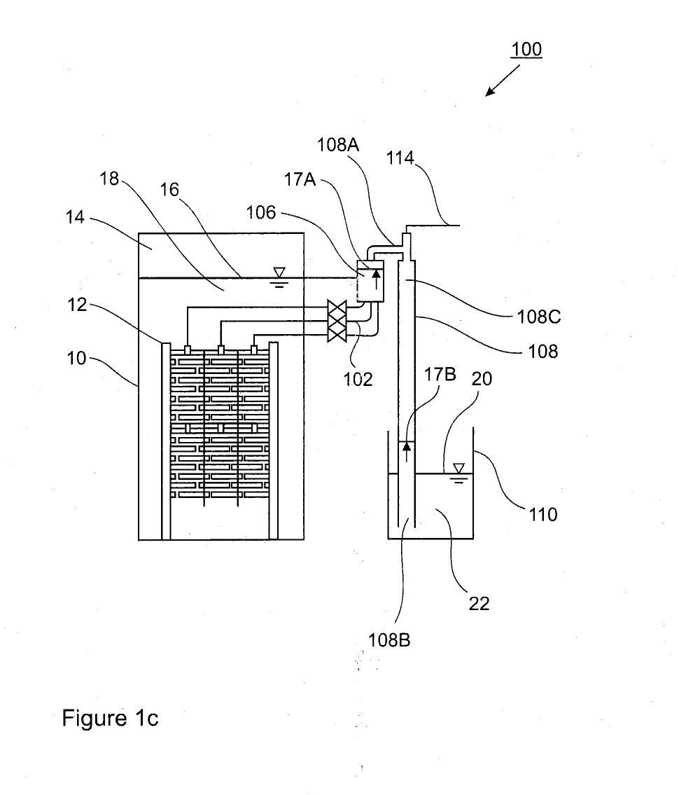

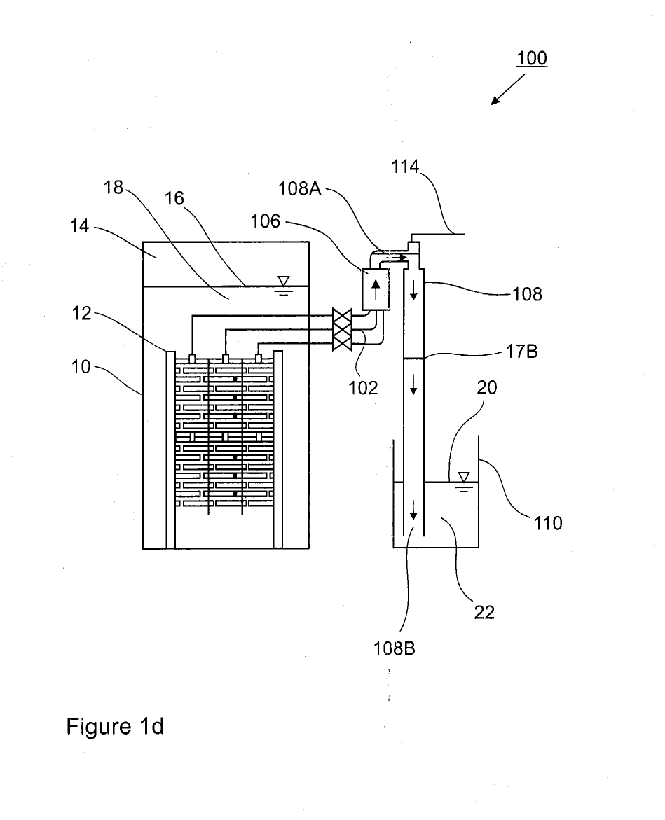

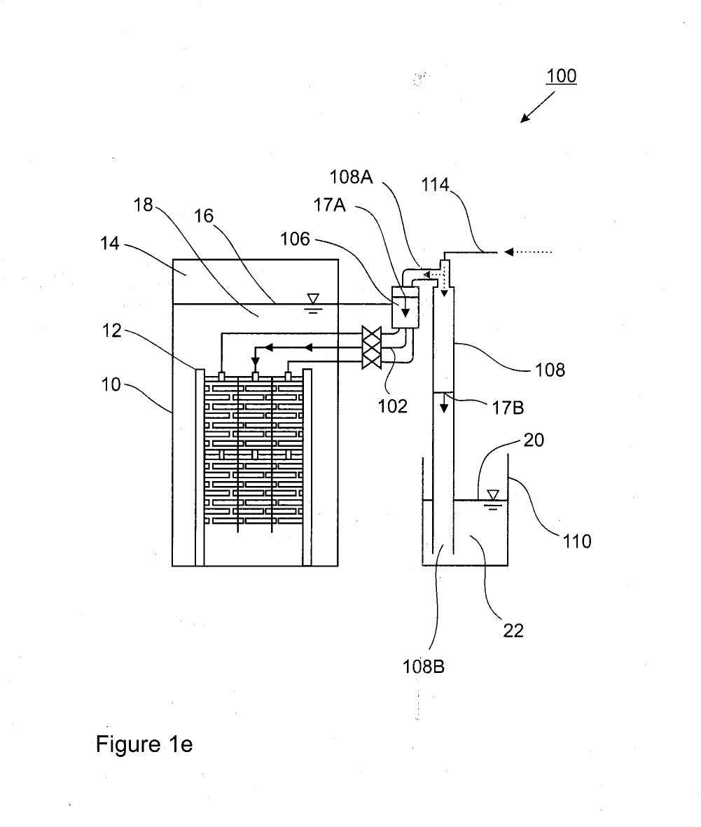

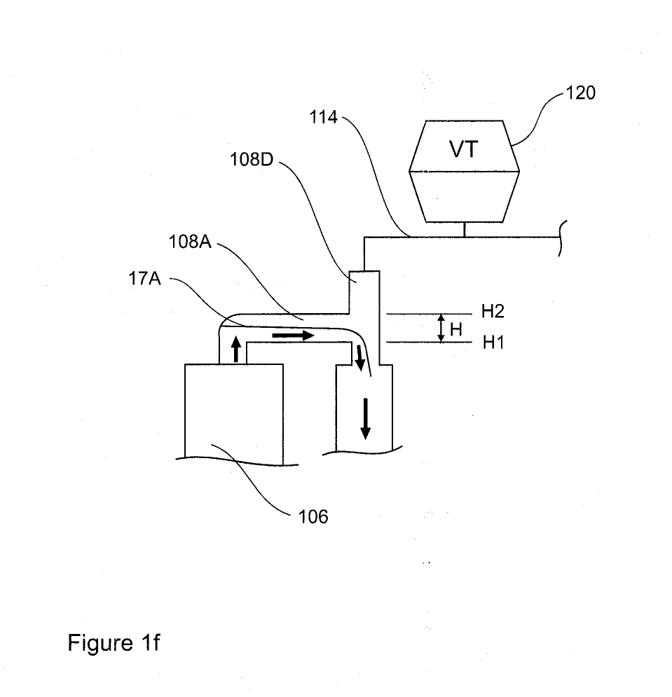

Referring to FIGS. 1a to 1f, a system 100 for actuating a water flow through a filter according to a first embodiment of the invention is provided. Filtrate withdrawal conduits 102 are connected to filter module 12 in a water sealing fashion for receiving filtrate therefrom. The filter module 12—comprising, for example, ultra-filtration membranes—is disposed in tank facility 10 and submerged in water 18 that is to be filtered. Typically, space 14 above the water surface 16 is exposed to ambient air pressure and the tank is filled with the water such that the water surface 16 is kept at an approximately constant level. Filtrate siphon 108 is connected to the filtrate withdrawal conduits 102 in a water sealing fashion. The filtrate siphon 108 actuates the flow through the filter 12 and the filtrate withdrawal conduit 102 into filtrate collector 110, as will be described herein below.

Filtrate siphon end portion 108B is disposed in the filtrate collector 110 such that in operation a predetermined length L of the end portion 108B is immersed in the collected filtrate 22, as illustrated in FIG. 1b. For example, filtrate gravity drain 112 is placed such that level 20 of the filtrate is the length L above the end of the siphon 108. Air conduit 114 is connected to filtrate siphon top portion 108A. Suction side 116A of air pump 116 is connected to the air conduit 114 for providing variable suction to the filtrate siphon 108. Pressure side 116B of the air pump 116 is vented to ambient air via vent 122. Furthermore, vent valve 118—for example, a solenoid valve—is connected to the air conduit 114 for venting the siphon 108. Pressure in the filtrate siphon top portion 108A is monitored using vacuum transmitter 120 such as, for example, a pressure sensor. As is evident to one of skill in the art, the technical term “vacuum” used herein is to be understood as referring to a vacuum in the range of “low vacuum”. A reverse flow storage tank 106 can be disposed in proximity to the top portion 108A of the siphon 108 for storing filtrate therein. Optionally, filtrate shut-off valves 104 are disposed in the filtrate withdrawal conduits 102, typically, for manual operation during maintenance or to shut off a membrane module that has experienced a membrane failure. The air pump 116 is implemented using, for example, a suitable off-the-shelf air pump. Optionally, the air pump 116 is omitted if there is another vacuum source available for being connected to the air conduit 114.

Referring to FIGS. 1b to 1f, various stages of operation of the system 100 are illustrated. FIG. 1b illustrates the system 100 in a shut-off stage, for example, after the vent valve 118 has been opened for “venting” the siphon 108 by providing ambient air thereto. At this stage the siphon 108 is filled with ambient air between the filtrate level 16 in the reverse flow storage tank 106—which is equivalent to the water level 16 in the tank 10 when the space 14 is exposed to ambient air—and the level 20 of the collected filtrate 22.

To initiate the flow through the filter 12 and to the filtrate collector 110, the vent valve 118 is closed and the air pump 116 is activated for providing suction to the siphon 108 via the air conduit 114. As illustrated in FIG. 1c, the suction provided by the air pump 116 generates a vacuum in the space 108C in the filtrate siphon 108, consequently raising the filtrate levels 17A and 17B until the filtrate level 17A reaches the top portion 108A of the filtrate siphon 108B and the filtrate flows down the siphon 108, as illustrated in FIGS. 1d and 1f.

The pressure in the filtrate siphon top portion 108A above the filtrate level 17A is monitored using vacuum transmitter 120 connected thereto via the air conduit 114 and the siphon extension 108D. The siphon extension 108D is provided to prevent water droplets from being drawn into the air pump 116 during evacuation of the siphon 108. Provision of a variable vacuum in a controlled fashion enables control of the flow rate of filtrate through the membranes. For example, provision of a higher vacuum raises the height H of the filtrate level 17A in the filtrate siphon top portion 108A enabling a variation of the height H between heights H1 and H2 corresponding to a low flow rate and a high flow rate, respectively. When a predetermined flow rate has been reached, the air pump 116 is shut off.

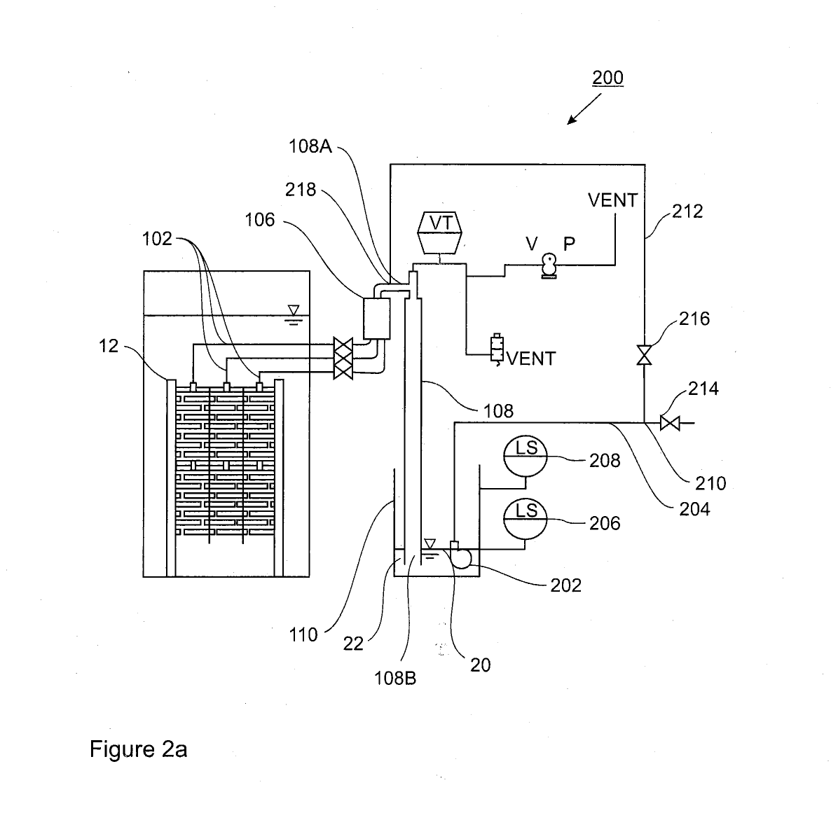

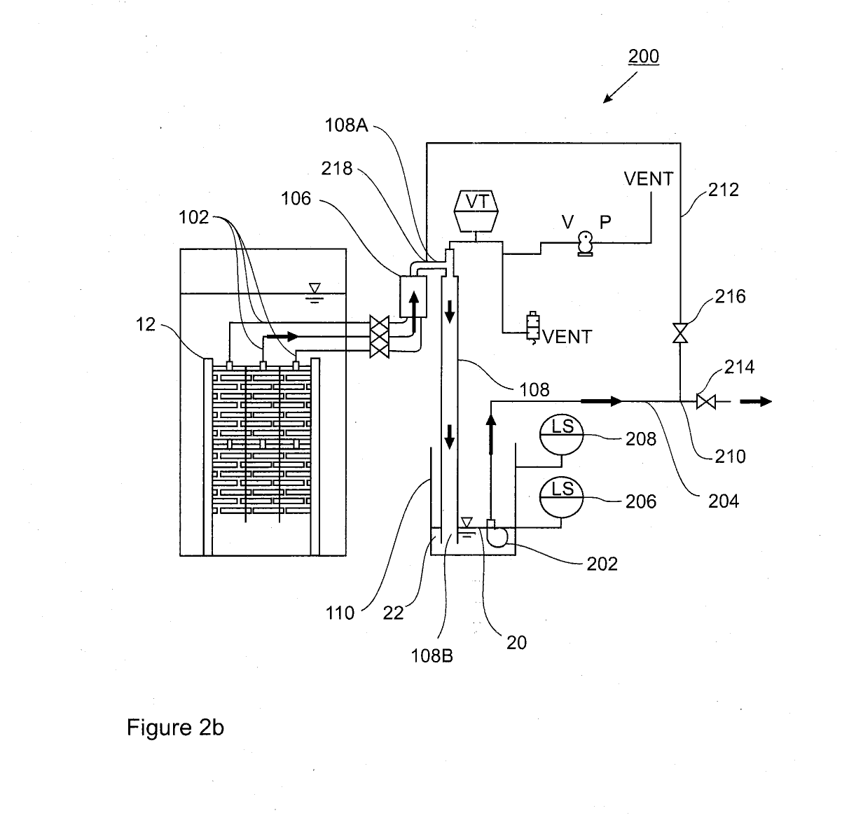

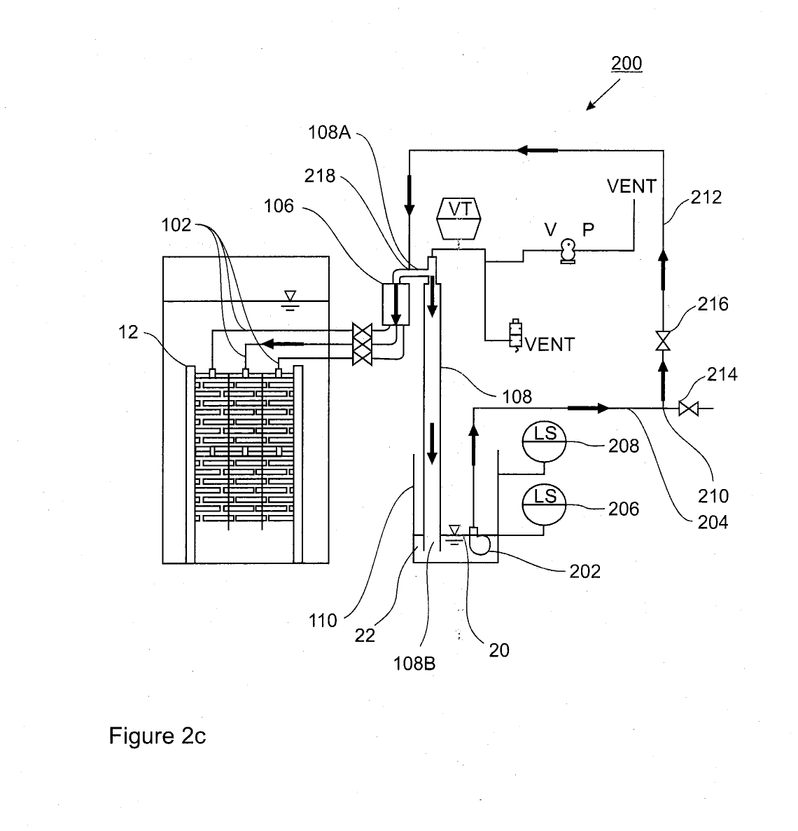

Furthermore, the air pump 116 and the vacuum transmitter 120 enable controlled provision of the vacuum in order to control provision of a constant flow rate of the filtrate as the membranes plug up. As the membranes plug up during the filtration process, a higher vacuum is needed to draw the water therethrough at a same flow rate. The vacuum is increased, for example, when a decrease in the flow rate is sensed—for example, by sensing the level of the filtrate surface 20 in the filtrate collector 110 or by measuring a flow rate of the discharged filtrate using a flow meter disposed in a discharge conduit such as, for example, discharge conduit 204 illustrated in FIG. 2a—or the vacuum is increased in a predetermined fashion depending on the time the filtration process has been performed since the last relaxation.

Automated control of the flow rate is enabled, for example, by sensing the flow rate and providing the vacuum in dependence upon the sensed flow rate. Alternatively, correlations between the flow rate, the time the filtration process has been performed since the last relaxation, and the corresponding vacuum, have been previously determined—for example, in an empirical fashion—and operation of the vacuum pump is controlled in dependence upon the signal provided by the vacuum transmitter 120 and the previously determined correlations.

To stop the flow through the filter 12 to the filtrate collector 110, the vent valve 118 is opened and ambient air vents the siphon 108 as indicated by the dashed arrows in FIG. 1e, thus breaking the flow of the filtrate through the siphon top portion 108A and causing a reverse flow through the filtrate withdrawal conduits 102 and the filter 12 as indicated by the solid arrows in FIG. 1e. The reverse flow storage tank 106 can be designed to be of sufficient size to provide a sufficient water to fully relax the filter 12.

The operation of the system 100 as described herein above enables implementation of various operating cycles of membrane filters such as, for example, drawing water through the membrane filters for approximately 9 minutes followed by a reverse flow for relaxing the membranes for approximately 5 seconds, with each cycle being implemented as a succession of the stages shown in FIGS. 1b to 1f.

Referring to FIGS. 2a to 2c, a system 200 for actuating a water flow through a filter according to another embodiment of the invention is provided. The system 200 comprises the same basic components as the system 100 with same reference numerals referring to same components. Here, the filtrate 22 is discharged using filtrate pump 202 connected to discharge conduit 204. The filtrate pump 202 is, for example, a suitable off-the-shelf water pump mounted to the outside of the filtrate collector 110 or disposed therein. Employment of the filtrate pump 202 enables discharge operation of the filtrate in dependence upon a fill level in the filtrate collector 110. The fill levels are measured using, for example, off-the-shelf electromechanical ball float level switches 206 and 208. For example, the filtrate pump 202 is activated when the fill level has reached the level to activate switch 208 and is stopped when the fill level has dropped low enough to deactivate switch 206, thus ensuring that overflow of the filtrate collector 110 is prevented as well as that the siphon end portion 108B is immersed in the filtrate.

Employment of the filtrate pump 202 enables implementing a cleaning system for cleaning the filter 12. The cleaning system comprises cleaning conduit 212 connected to the discharge conduit 204 at 210 and to one of: the siphon top portion 108A; the reverse flow storage tank 106; and the filtrate withdrawal conduits 102, as well as discharge shut-off valve 214 and cleaning valve 216. The discharge shut-off valve 214 and cleaning valve 216 are implemented using, for example, off-the-shelf electromechanical or manually operated valves.

In a first mode of operation, the discharge shut-off valve 214 is opened while the cleaning valve 216 is closed, enabling discharge of the filtrate 22—collected in the filtrate collector 110 during normal filtering operation—through the discharge conduit 204, as indicated by the arrows illustrated in FIG. 2b. For cleaning the filter 12, the discharge shut-off valve 214 is closed while the cleaning valve 216 is opened for re-circulating the filtrate into the one of: the siphon top portion 108A; the reverse flow storage tank 106; and the filtrate withdrawal conduits 102, as indicated by the arrows illustrated in FIG. 2c, with excess filtrate flowing back through the siphon into the filtrate collector 110. The cleaning process is implemented, for example, for being performed in an automated fashion in predetermined time intervals by controlling the filtrate pump 202, the discharge shut-off valve 214 and the cleaning valve 216 for switching between the filtering operation and the cleaning operation. Alternatively, the cleaning process is implemented as a manual process allowing an operator to add chemicals to the filtrate 22 prior recirculation of the filtrate 22.

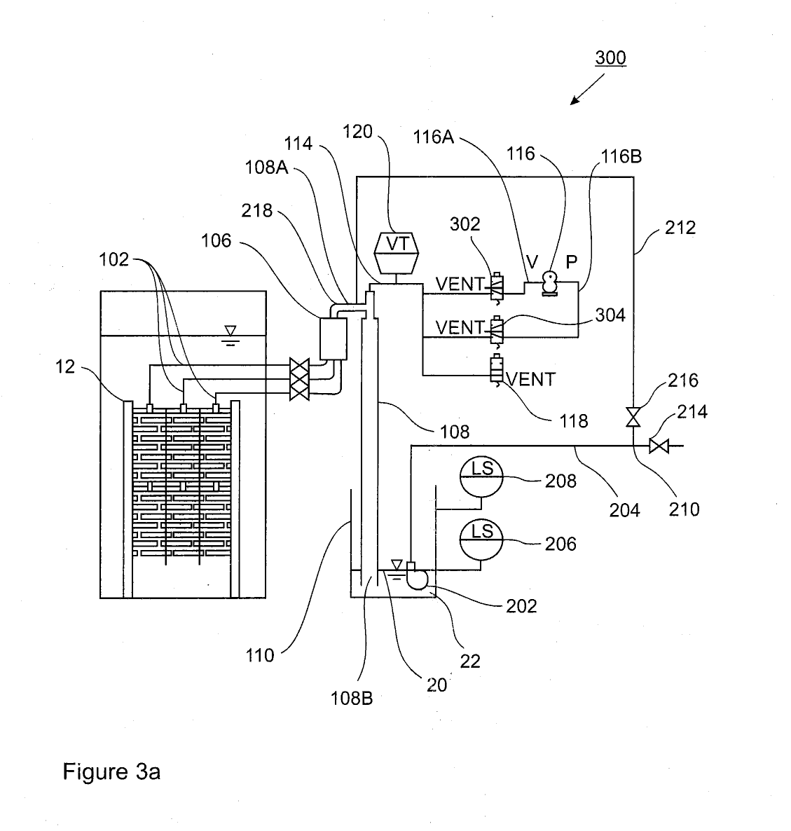

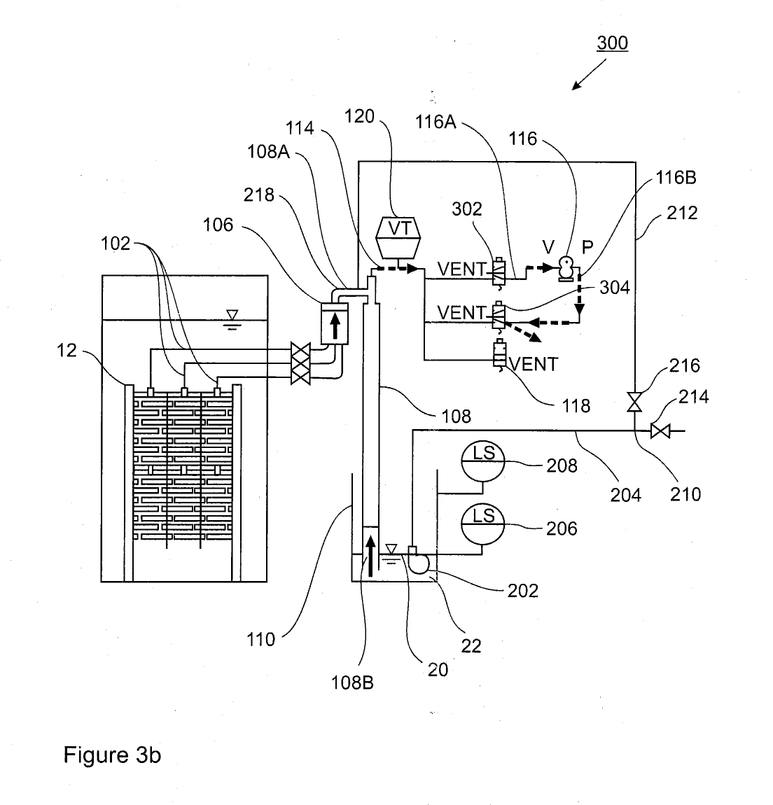

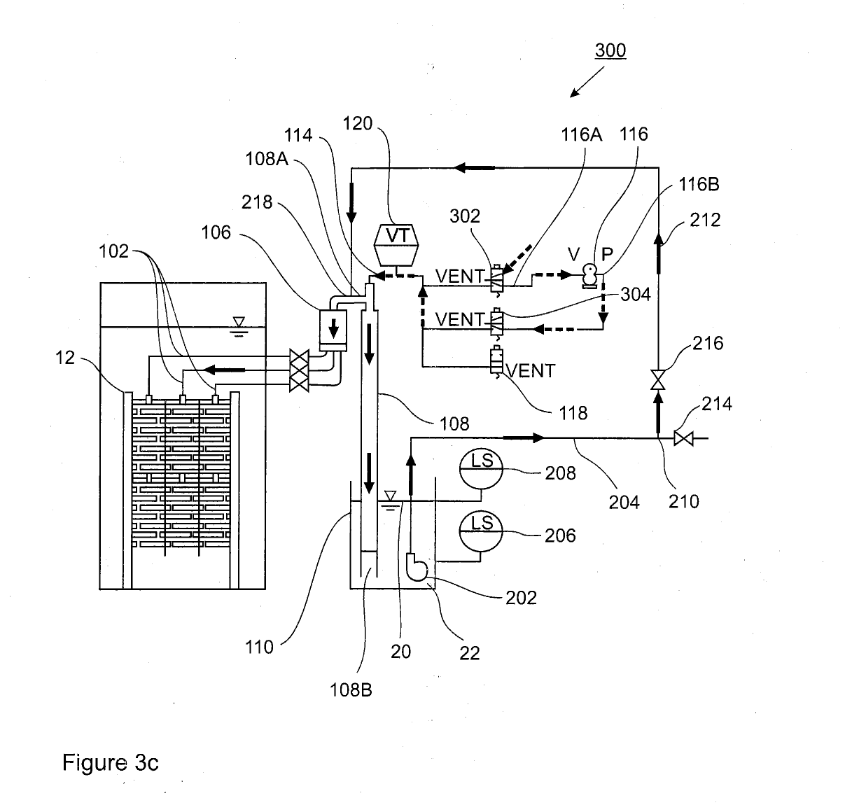

Referring to FIGS. 3a to 3c, a system 300 for actuating a water flow through a filter according to yet another embodiment of the invention is provided. The system 300 comprises the same basic components as the system 200 with same reference numerals referring to same components. The system 300 comprises a pressurizing mechanism for enabling pressurized recirculation of the filtrate 22. The pressurizing mechanism comprises: a suction air valve 302 interposed between the suction side 116A of the air pump 116 and the air conduit 114; and a pressure air valve 304 interposed between the pressure side 116B of the air pump 116 and the air conduit 114.

In a first mode of operation, illustrated in FIG. 3b, the suction air valve 302 connects the suction side 116A of the air pump 116 to the air conduit 114 for evacuating the siphon 108—corresponding to FIG. 1c—while the pressure air valve 304 connects the pressure side 116B of the air pump 116 to the outside ambient air, as illustrated by the dashed arrows in FIG. 3b.

In a second mode of operation, illustrated in FIG. 3c, the pressure air valve 304 connects the pressure side 116B of the air pump 116 to the air conduit 114 for providing pressurized air to the siphon 108 and, therefore, to the filtrate for cleaning the filter 12—corresponding to FIG. 2c—while the suction air valve 302 connects the suction side 116A of the air pump 116 to the outside ambient air, as illustrated by the dashed arrows in FIG. 3c. During this operation, it may be desired to keep a high fill level in the filtrate collector 110 to ensure sufficient pressurization of the filtrate siphon 108 by controlling pump 202 on level switch 208 rather than level switch 206. The pressurized air is provided in a controlled fashion, for example, by enabling an operator to adjust an air pressure setpoint.

In one case the suction air valve 302 and the pressure air valve 304 are in a closed position when the air pump 116 is shut off. The pressurizing mechanism is implemented, for example, for being performed in an automated fashion by controlling the air pump 116, the suction air valve 302 and the pressure air valve 304 for switching between the filtering operation and the cleaning operation. The suction air valve 302 and the pressure air valve 304 are implemented using, for example, off-the-shelf 3-way solenoid valves.

The pressuring mechanism enables installation of a filtration system, for example, for wastewater treatment, without having to install additional tanks and equipment on the roof of the container for the filter cleaning process.

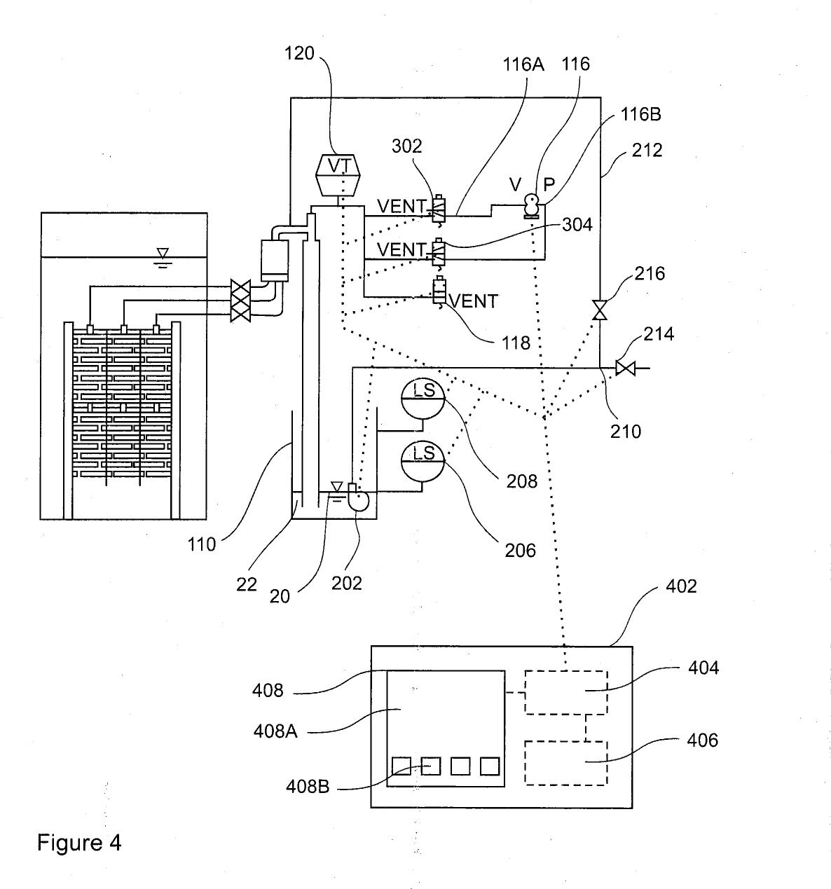

Operation of the above systems for actuating a water flow through a filter can be performed in an automated fashion. Referring to FIG. 4, a control unit 402 is provided for controlling the operation of the various components. Operation of the control unit 402 is enabled using an off-the-shelf Programmable Logic Controller (PLC) 404 for executing executable commands which can be stored in non-volatile memory 406 on board the PLC. The PLC 404 is connected to the sensors 120, 206, and 208 for receiving sensor data therefrom, as well as to the valves 118, 214, 216, 302, and 304; and, to the air pump 116 and the filtrate pump 202 for controlling operation of the same in dependence upon the executed commands and the sensor data. A user interface 408 is disposed in the control unit 402 and connected to the processor 404 for displaying display data to the operator 408A in a human comprehensible fashion and for receiving operator commands 408B. For example, the operator is enabled to provide user input data relating to the operation of the system such as duration of the various operating cycles, the flow rate, etc. The user interface 408 is provided using, for example, an off-the-shelf touch screen or a combination of a display and push buttons. The control unit 402 may be provided in a rugged fashion for outdoor use and to withstand substantial vibrations generated during transport and operation of the filtration system.

The above systems for actuating a water flow through a filter are manufactured depending on the application—for example, wastewater treatment or potable water filtration—using: standard materials such as, for example, steel, stainless steel, or suitable plastic materials; standard manufacturing processes such as, for example, welding, use of screw fittings, or use of adhesives; and off-the-shelf components such as, for example, off-the-shelf piping and off-the-shelf fittings. The design of the above systems is performed using standard engineering technologies for water treatment systems.

In an example, implementation an MBR wastewater treatment system was built for processing wastewater from a 50 man mining camp. The water treatment flow rate is 12,500 liters/day. The whole treatment system was assembled in a 8′×40′ pre-fabricated portable building. The membrane tank is 40″ long×49″ wide and 97″ tall. There were 6 membrane packs installed in this tank, each capable of processing 2,450 liters/day at full capacity. The tank water level in the membrane tank is at 7′ 10″ high and activated sludge is re-circulated through the membrane tank from the aeration tank and back to the aeration tank via an overflow pipe. This water is recirculated at 72,000 liters/day. Water is then drawn through the membranes with the siphon actuated filtration process at a maximum flow rate of 12,500 liters/day.

The lines 102 are 1″ diameter lines and feed 106 which is a 4″ diameter×16″ long clear PVC pipe. The height from the midpoint of 108A to the static water level in the membrane tank 16 is 7.8″. The extension 108d is 4″ above the midpoint of 108A. The main body of 108A is 8′4″ tall and sits 2″ above the bottom of tank 110. The air tubing 114 is 1″ diameter and is connected to a ½″ solenoid valve and to an air vacuum pump that will draw 5 cfm at maximum vacuum of 120″ wc. The discharge tank is 22″ diameter and 48″ tall. LS 206 is located 8″ above the bottom of the tank and LS 208 is located 36″ above the base of the tank.

The water discharge line from pump 202 may be designed for maximum water flow 50,000 liters/day. Cleaning loop 212 is all 1″ diameter.

The variable vacuum drawn by the vacuum pump will vary when operating between 20″ wc vacuum and 82″ wc vacuum depending on the degree of plugging of the filter.

The present invention has been described herein with regard to certain embodiments. However, it will be obvious to persons skilled in the art that a number of variations and modifications can be made without departing from the scope of the invention as described herein.

What is claimed is:

1. A system for actuating a water flow through a filter comprising:
a filtrate withdrawal conduit for being connected to the filter in a water sealing fashion for receiving filtrate therefrom;
a filtrate collector in fluid communication with the filtrate withdrawal conduit for collecting the filtrate;
a filtrate siphon interposed between the filtrate withdrawal conduit and the filtrate collector;
an air conduit connected to a top portion of the filtrate siphon; and,
a suction mechanism connected to the air conduit, the suction mechanism for providing suction to the filtrate siphon sufficient for drawing the filtrate to the top portion of the filtrate siphon for actuating the water flow through the filter and the flow of filtrate from the filter to the filtrate collector.

2. A system as defined in claim 1 comprising a pressure sensor in fluid communication with the air conduit, the pressure sensor for sensing a pressure in the air conduit and providing a signal in dependence thereupon.

3. A system as defined in claim 2 comprising a controller connected to the pressure sensor and the suction mechanism, the controller for controlling provision of the suction in dependence upon the signal provided by the pressure sensor and a predetermined flow rate of the filtrate.

4. A system as defined in claim 1 wherein an end portion of the filtrate siphon is disposed in the filtrate collector such that in operation a predetermined length of the end portion is immersed in the collected filtrate.

5. A system as defined in claim 1 comprising a vent valve connected to the air conduit, the vent valve for venting the siphon.

6. A system as defined in claim 1 comprising a reverse flow storage tank interposed between the filter and the top of the siphon, the reverse flow storage tank for storing filtrate for providing a reverse flow through the filter when the siphon is vented.

7. A system as defined in claim 1 comprising a filtrate pump for pumping the filtrate from the filtrate collector into a filtrate discharge conduit connected thereto.

8. A system as defined in claim 7 comprising a cleaning conduit connected to the filtrate discharge conduit and connected to one of: the filtrate withdrawal conduit; the top portion of the filtrate siphon; and a reverse flow storage tank interposed between the filter and the top of the siphon.

9. A system as defined in claim 7 wherein the suction mechanism comprises an air pump, the system comprising:
a suction air valve interposed between a suction side of the air pump and the air conduit; and,
a pressure air valve interposed between a pressure side of the air pump and the air conduit, the pressure air valve in concert with the suction air valve for switching between provision of suction and provision of pressurized air to the air conduit.

10. A method for actuating a water flow through a filter comprising:
connecting a filtrate withdrawal conduit to the filter in a water sealing fashion for receiving filtrate therefrom;
providing a filtrate collector in fluid communication with the filtrate withdrawal conduit;
interposing a filtrate siphon between the filtrate withdrawal conduit and the filtrate collector such that in operation a predetermined length of the end portion of the filtrate siphon is immersed in the collected filtrate; and
providing suction to the filtrate siphon sufficient for drawing the filtrate to the top portion of the filtrate siphon for actuating the water flow through the filter and the flow of filtrate from the filter to the filtrate collector.

11. A method as defined in claim 10 comprising controlling the provision of the suction for controlling a flow rate of the filtrate.

12. A method as defined in claim 11 wherein the provision of the suction is controlled such that the flow rate of the filtrate is substantially constant during filtration.

13. A method as defined in claim 10 comprising sensing a pressure associated with a pressure in the top portion of the filtrate siphon and providing the suction in dependence thereupon.

14. A method as defined in claim 10 comprising venting the siphon to stop the flow of filtrate.

15. A method as defined in claim 14 providing a reverse flow through the filter when the siphon is vented.

16. A method as defined in claim 15 wherein the siphon is vented in predetermined time intervals.

17. A method as defined in claim 10 comprising pumping the filtrate from the filtrate collector into a filtrate discharge conduit.

18. A method as defined in claim 17 wherein the pumping is initiated when the filtrate in the filtrate collector has reached a predetermined maximum level and wherein the pumping is stopped when the filtrate in the filtrate collector has reached a predetermined minimum level.

19. A method as defined in claim 10 pumping a cleaning liquid from the filtrate collector through the filter.

20. A method as defined in claim 19 providing pressure acting on the cleaning liquid.

21. A method as defined in claim 20 wherein air pressure is provided to a top portion of the filtrate siphon.
